(19) United States
(12) Patent Application Publication
(10) Pub. No.: US 2005/0216553 A1
(43) Pub. Date: Sep. 29, 2005

(54) Mobile apparatus, method and system for delivery management

(76) Inventors: Cynthia F. Mallonee, Huntington, MD (US); George R. Kelly, Crofton, MD (US)

Correspondence Address: FINNEGAN, HENDERSON, FARABOW,;GARRETT & DUNNER, L.L.P., 55 Cambridge Parkway, Cambridge, MA, 02142-1292, US

(21) Appl. No.: 10/955,415

(22) Filed: Sep. 30, 2004

Related U.S. Application Data
(60) Provisional application No. 60/543,919, filed on Feb. 13, 2004.

(51) Int. Cl. G06F 15/16

(52) U.S. Cl. 709/203

(57) ABSTRACT

A mobile apparatus, system and method for delivery management are provided. The delivery management system comprises a web based server comprising an application server and a database server, a mobile delivery management tool, and a wireless communication device for connecting the mobile delivery management tool and the web based server. Also provided is a method for managing delivery of a package using the apparatus and system of the present invention. Data related to the package to be delivered may be received using the mobile delivery management tool, which then processes the received data to determine an appropriate delivery action to be taken. The delivery action may be, for example, the selection of a delivery route, a scheduled delivery time, or a loading order.

### CROSS-REFERENCE TO A RELATED APPLICATION

This application claims the benefit of U.S. Provisional Application No. 60/543,919, filed Feb. 13, 2004.

### FIELD OF THE INVENTION

This invention relates generally to a system for tracking goods to be delivered. More specifically, the invention relates to a delivery management system that utilizes a mobile device to enable in-transit tracking of the transportation supply chain, and methods for using the system and device.

### BACKGROUND OF THE INVENTION

Today, the reliable and efficient transportation and distribution of commerce are a critical part of any country's economy. Almost everything around us has been transported at some time from a manufacturer to a consumer. To provide quality transportation and distribution service, a transportation service provider must create and maintain a highly organized and integrated network for tracking its transportation supply chain. Included within this chain are assets such as the goods to be delivered, shipping carriers including land, air and water delivery vehicles, loading docks, storage and holding facilities, and human resources (i.e., personnel in the delivery and/or distribution chain such as, for example, delivery truck drivers and package handlers). Effective management of such a network allows for lower cost, reduced delivery time, and enhanced customer service. Management of an integrated transportation network may include management of asset tracking infrastructure and logic, management of distribution, and management of information services supporting tracking and tracing of items in transit. Another important component of an integrated transportation network is proactive management of the transportation supply chain from the induction to the destination stage.

To plan, maintain, and optimize an integrated transportation network, a service provider needs to provide to the network real time data related to in-transit tracking of the service provider's assets. Currently, most real time data is gathered and manually input into a network by service provider employees. In the process of gathering data, employees often have to make best-guess estimates as to the numerical value of certain parameters. For example, an employee may have to estimate a load capacity of a truck or a remaining load capacity of a truck available after an initial loading.

As an input interface for an integrated transportation network, a service provider may utilize data terminals. Such terminals are usually located in offices while loading and unloading of transportation trucks takes place at a dock, away from the office. Typically, a service provider employee, wishing to input real time data into a network, has to start with manually recording gathered information into a hand-held media, such as for example, a notebook. Then, the employee has to go to a desktop terminal and manually transfer the recorded information into a network. Some data may not be entered immediately upon collection. In addition, some data may be inaccurately transferred into the database as a result of human error. Finally, an employee wishing to look up certain information stored in that database may be forced to leave a loading/unloading area of a dock and go to an office area where the terminal is located. It is therefore desirable to provide a delivery management system and methods that utilize a mobile tracking device to enable a service provider employee to gather, directly input, monitor, and manage in real time data related to in-transit tracking of the service provider's assets.

### SUMMARY OF THE INVENTION

In accordance with the invention, a mobile apparatus, method and system for delivery management are provided. In one embodiment, the system for delivery management comprises a web based server comprising an application server and a database server, a mobile delivery management tool, and a wireless communication device for connecting the mobile delivery management tool and the web based server. At least one work station may be provided for accessing the web based server. The mobile delivery management tool may also comprise a memory for providing sufficient processing power and a storage for maximizing application performance. The web based server includes at least one of package delivery information, delivery vehicle information, and delivery personnel information that may be obtained from and communicated to the mobile delivery management tool.

In another embodiment, a method for managing delivery of a package is provided. The method involves providing a system for delivery management which comprises a web based server comprising an application server and a database server, a mobile delivery management tool, and a wireless communication device for connecting the mobile delivery management tool and the web based server. Data related to the container, package, and/or delivery vehicle may be received using the mobile delivery management tool, which then processes the received data to determine an appropriate delivery action to be taken. The delivery action may be, for example, the selection of a delivery route, a scheduled delivery time, or a loading order.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

In the drawings:

FIG. 1 is an illustration of an exemplary generic mobile tracking device in accordance with the present invention.

FIG. 2 is a block diagram depicting exemplary components of mobile tracking device in accordance with the present invention.

FIG. 3 is a block diagram depicting an exemplary architecture of a server included in an integrated transportation network in accordance with the present invention.

FIG. 4 is a block diagram depicting an exemplary structure of a connection between an integrated transportation network and an individual mobile tracking device in accordance with the present invention.

FIG. 5 is a flowchart of an exemplary process for authenticating a user attempting to log onto a network in accordance with present invention.

FIG. 6 illustrates a screen of a generic mobile tracking device with an exemplary main page in accordance with the present invention.

FIG. 7 is a flowchart of an exemplary process for verifying and updating a mobile tracking device's application code in accordance with the present invention.

FIG. 8 illustrates a screen of a generic mobile tracking device showing a first exemplary page of a data form in accordance with the present invention.

FIG. 9 illustrates a screen of a generic mobile tracking device showing a second exemplary page of a data form in accordance with the present invention.

FIG. 10 illustrates a screen of a generic mobile tracking device showing a third exemplary page of a data form in accordance with the present invention.

FIG. 11 illustrates a screen of a generic mobile tracking device showing an exemplary dock status form in accordance with the present invention.

FIG. 12 illustrates a screen of a generic mobile tracking device showing an exemplary trailer details form in accordance with the present invention.

FIG. 13 illustrates a screen of a generic mobile tracking device showing an exemplary inbound mode page in accordance with the present invention.

FIG. 14 illustrates a screen of a generic mobile tracking device showing an exemplary trailer assignment form in accordance with the present invention.

FIG. 15 illustrates a screen of a generic mobile tracking device showing an exemplary barcode scanning form in accordance with the present invention.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts.

To enable a transportation service provider's employee to gather and directly input real time data in the most efficient way, a service provider may provide an employee with a mobile device wirelessly connected to a service provider's network. Having a mobile device directly connected to the service provider's network may increase productivity and eliminate an extra step of manually transferring recorded information into a network database. The mobile device also enables the user to track, or monitor, deliverable units such as trailers, containers, and individual packages, each of which can be nested within one another (i.e., a trailer can contain at least one container, which can contain at least one package). The units are identifiable by their unique ID number, which can be in the form of a barcode. By tracking the real-time movement of deliverable units, efficient delivery management can be achieved.

The features of the present invention may be implemented in various system or network environments to provide automated computational tools to facilitate management of deliverable goods. Such environments and applications may be specially constructed for performing the various processes and operations of the invention, or they may include a general-purpose computer or computing platform selectively activated or reconfigured by program code to provide the necessary functions. The processes disclosed herein are not inherently related to any particular computer or other apparatus, and may be implemented by a suitable combination of hardware, software, and/or firmware. For example, various general-purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well known and available to those skilled in the computer software arts. Examples of program instructions include both machine code, such as the type produced by a compiler, and files containing a high level code that can be executed by the computer using an interpreter.

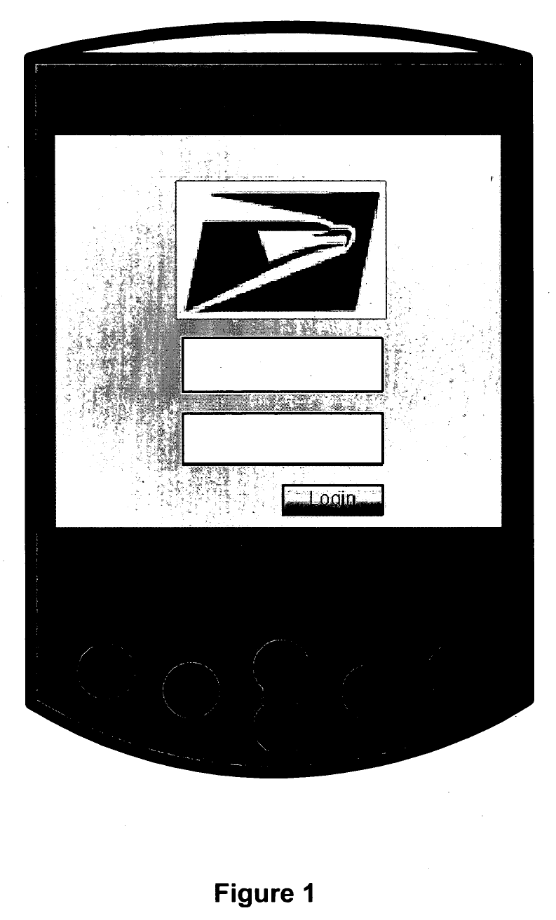

FIG. 1 depicts an exemplary generic mobile tracking device 100, which can take the form of a personal digital assistant (PDA), as shown. Such a PDA or device 100 may include a button keypad located underneath the screen for entering data (not shown). In another example, a device 100 may have a virtual keypad located within its screen (not shown). In yet another example, a user may enter data using a pressure sensitive handwriting option or by clicking on keyboard icons.

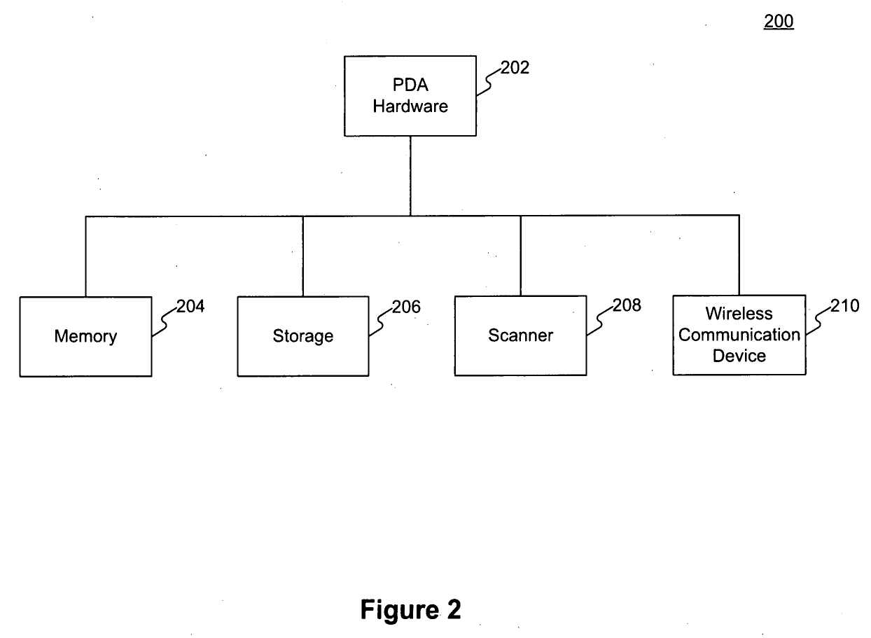

FIG. 2 depicts components of a mobile device hardware 202 that a service provider may use for a mobile application 200. To provide sufficient processing power with reliable upload time, mobile device hardware 202 may include a memory component 204, such as for example, 128 MB of RAM. To optimize management of data in memory and maximize application performance and storage, the mobile device 100 may include auxiliary storage 206. A scanner 208 may be included to provide an interface for entering data into a database. For example, a wearable scanner such as, for example, a barcode reader, may be affixed to an employee's arm. An employee then may use a finger trigger or a hands-free input to fire. the barcode reader. In yet another embodiment, an employee may use a pistol scanner by retrieving a scanner from a hip holster. In another example, a different type of hands-free scanner may be used, such as re-mountable scanner. A re-mountable scanner may have a magnetic base so that it may be easily mounted and removed from transport containers. After the scanner is used to scan a bar code of a container, an employee may attach the magnet base of the scanner to the container. Thus, the mobile device user can easily track and monitor deliverable units such as trailers, containers, and individual packages, by scanning their identification barcodes into the network for delivery management.

To support direct transfer of collected and scanned data into an integrated transportation network database, the mobile device 100 may include a wireless communication device 210. For example, a wireless communication device, such as a WLAN communication device, may be used to connect individual mobile devices to an integrated transportation network via, for example, Wireless Access Point, such as Cisco WLAN access point. Access points may be placed by a service provider within its facility. A service provider may choose the location and number of access points at each facility. A service provider may also choose a maximum distance between a PDA and an access point device necessary for connection. For example, a service provider may choose to have fifteen access points at a facility, with a maximum of about 150 ft distance required for connection between a PDA and an access point.

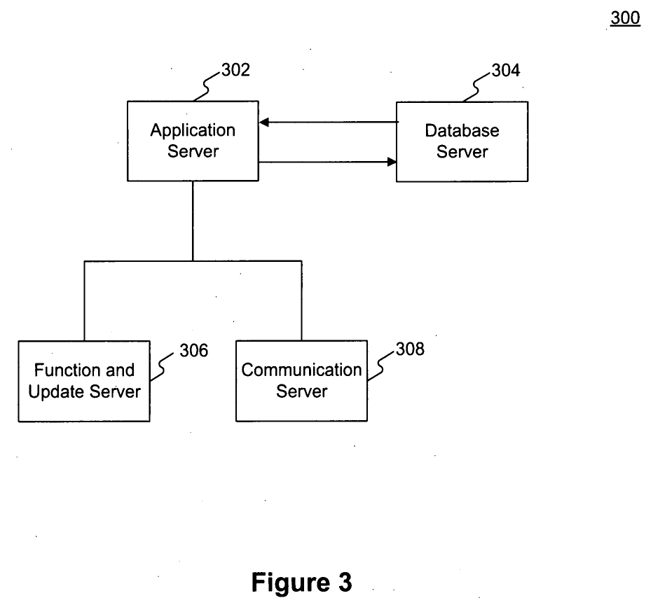

An integrated transportation network may include a web application. FIG. 3 depicts an exemplary architecture of a server hosting a web application for an integrated transportation network. A network 300 may be installed on a two-server environment running an operating system such as, for example, Windows Server 2000, an application server 302, and a database server 304. Application server 302 and database server 304 may be networked with each other. Application server 302 may consist of a function and update server 306 and a communication server 308. Function and update server 306 may be equipped with software for providing web server functions and updates, such as for example, IBM WebSphere Application Server 5.0. Communication server 308 enables communication of network 300 with wireless devices, such as individual mobile devices. Communication server 308 may upload and download data packets and programs, such as for example, NetS24. A database server 304 may be equipped with software enabling storage and management of data, such as for example, Oracle 9i.

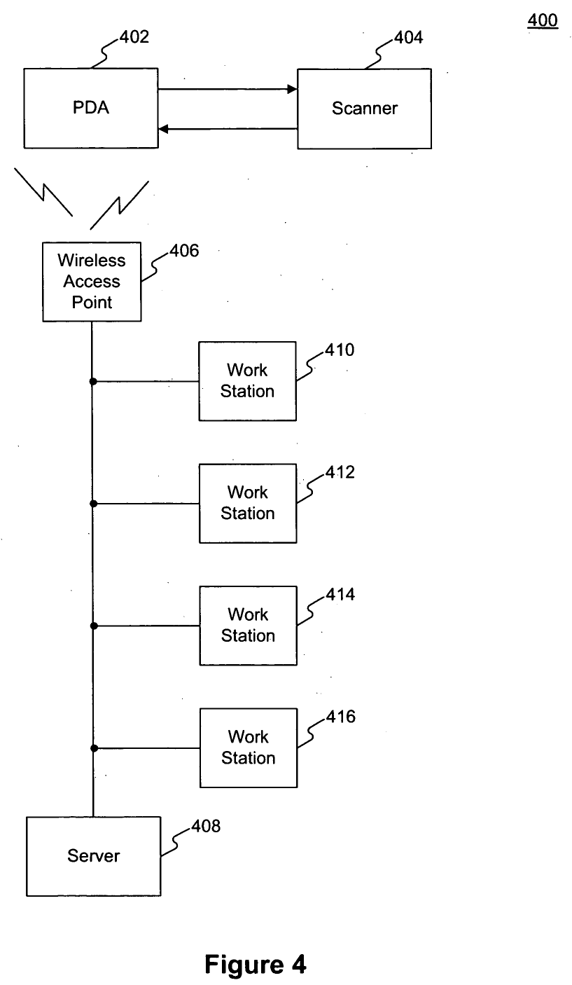

FIG. 4 depicts an exemplary structure of a connection between integrated transportation network 400 and an individual PDA 402. PDA 402 may receive scanned data from a scanner 404. A PDA 402 then may wirelessly transfer to a wireless access point 406 both scanned data received from the scanner 404 and data manually entered by a service provider employee. For example, an employee may scan a bar code of a deliverable unit (e.g., package, shipping container, trailer, etc.) with a scanner and then manually enter additional data such as a name or employee ID number of a driver. All this information may then be transferred from the PDA 402 through wireless access point 406 to a server 408 for processing and management. Data also may be entered into a network through one of a plurality of work stations 410, 412, 414, or 416. It is contemplated that any number of work stations may be implemented, and that a service provider may decide how many stations may be used to access a network to achieve the intended purpose.

Certain data also may be downloaded from server 408 onto the individual PDA 402. For example, date and time information may be automatically transferred from server 408 to PDA 402 every time a connection between them is established. In another example, certain default information, such as a location code for PDA 402 or codes of destinations available for PDA 402 based on its current location may be automatically transferred to PDA 402 from server 408.

To safeguard an integrated transportation network and secure transfer of data between PDAs and a network, a service provider may use an encryption application, such as for example, 128 bit WEP encryption. In another embodiment, to increase safety of data transfer and management, terminal access to a database may be allowed only from an application server.

In yet another embodiment, a network may include a directory of all authorized users. Such. a directory may include lists of all authorized users and their respective passwords. A network may authenticate and subsequently authorize an entry of data from a user by comparing and validating credentials of the user against the directory.

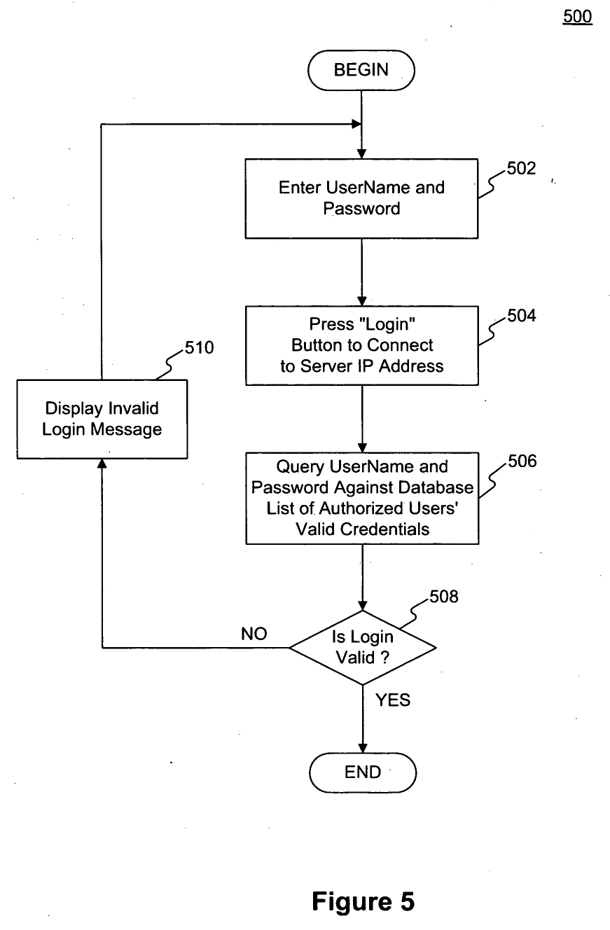

FIG. 5 is a flowchart of an exemplary process for authenticating a user attempting to log into network 500. In this embodiment, a user wishing to log into network 500 may enter his or her username and a password using a mobile device such as a PDA 402 (step 502). A password may be displayed on a PDA screen as a string of asterisks for security purposes. Then a user may push a “Login” button on the PDA (step 504). Pushing the “Login” button may result in the PDA attempting to connect to a network server IP address via an access point (step 504). Once a connection to the service provider's network is established, a web service application may query the received username and password against its list of authorized users and attempt to validate the entered credentials (step 506). If the network login username and password are valid, the user is allowed to continue connecting to a network (step 508). If the server is unable to match the entered username and password with its existing list of credentials, the connection with the network 500 is discontinued and the user may receive a message that the login username and/or password are invalid (step 510). The user may be prompted to repeat the above steps until access is obtained. Alternatively, the application may allow only a limited number of tries (e.g., no more than three failed attempts) before discontinuing the login process.

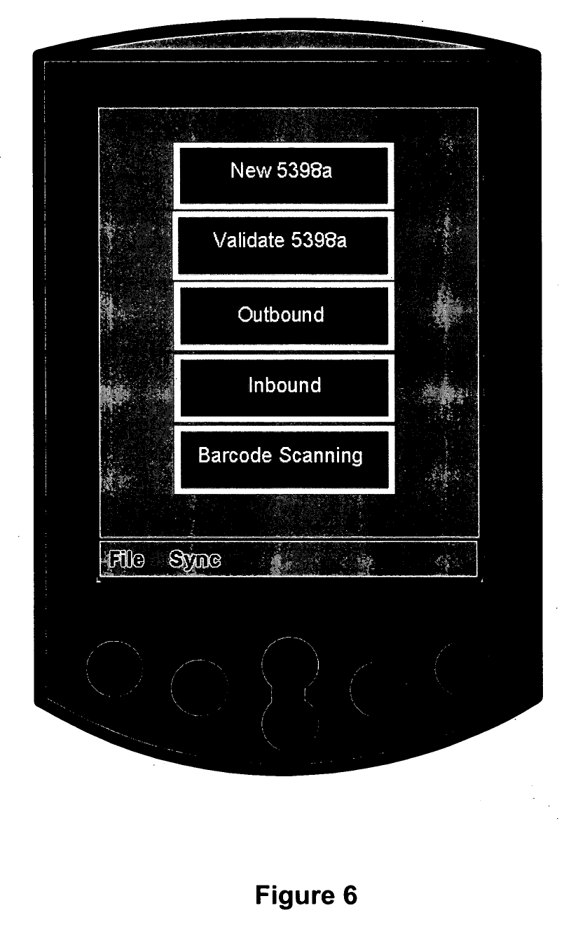

Once the user has successfully logged in, a main page displaying all available main functions may appear. FIG. 6 depicts a PDA screen with an exemplary main page. Main functions may include creating or updating major forms a service provider uses for its transportation units. For example, as shown in FIG. 6, function keys for generating a new data capture form (such as exemplary form 5398a) and for validating the data capture form are provided. It is understood, however, that other keys corresponding to other major service provider forms may be provided instead of, or in addition to, the exemplary data capture form 5398 function keys illustrated. The main page may also include different modes of the PDA operation, such as for example, the outbound status, inbound status, and barcode scanning features. An employee may choose between any of the modes by touching the respective icon on the PDA screen.

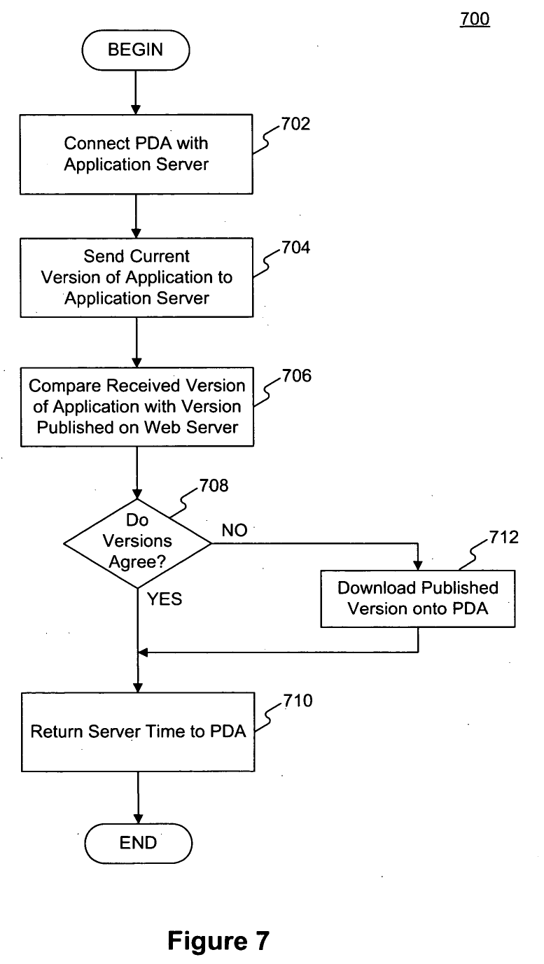

In the alternative embodiment, prior to displaying the main page, the PDA 402 may verify that it is running the latest version of the application code. FIG. 7 depicts a flowchart of an exemplary process for verifying and updating the PDA 402 application code 700. Once the PDA is connected to an application server (step 702), the PDA may send an identifier of the current version number of the web service application to an application server (step 704). When the application server receives the web service application version number from the PDA, it may compare the received version number with an application version number published on a web server (step 706). If application version numbers are identical, the server may confirm that no update is necessary by returning a message containing the current time to the PDA (step 710). If compared application version numbers disagree, the web server may initiate a download of a current application version into the PDA memory (step 712). Once the download is complete, the web server may confirm that an update is finished by sending a confirmation message, such as a message containing the current time, to the PDA (step 710). In another example, a comparison of the application version numbers may be performed once a day or once a week, as deemed appropriate by the service provider.

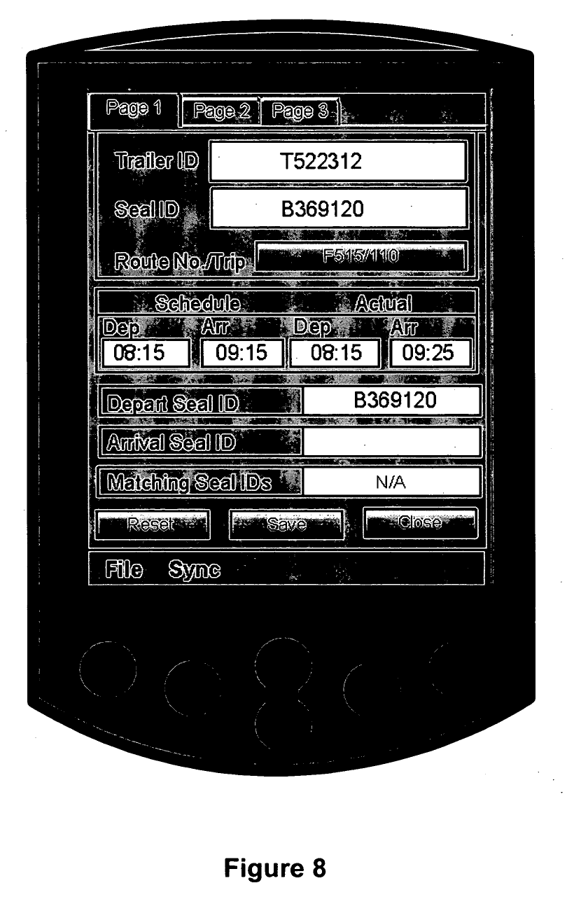

After the service provider employee successfully logs in, the employee may start filling out or reviewing an electronic data form containing information about the delivery or deliveries scheduled to be made. FIG. 8 depicts a screen of a generic PDA with a first exemplary page of such a data form. The first page of the data form may feature fields for scanned bar code information, such as a delivery truck or trailer ID, a seal ID (i.e., package identification number), a depart seal ID, and an arrival seal ID. By depart seal ID what is meant is the package identification number as scanned or entered just prior to, or upon departure. By arrival seal ID what is meant is the package identification number as scanned or entered upon reaching its destination. Thus, as shown in FIG. 8, the identification numbers are compared to determine that the proper package has indeed been loaded and delivered as scheduled.

The first page may also feature fields for default information downloadable from the network server upon its connection to the PDA. For example, the network server may automatically download into the PDA an actual arrival time of a trailer or a list of available routes for that trailer. In another example, scanning a trailer ID may trigger a network application to populate the data form fields with route and trip information. In yet another example, upon selection of a trip, scheduled departure and arrival times may be displayed on the PDA screen. In this example, actual departure and arrival time fields may remain blank when an electronic data form is opened for a trailer that is at its point of origin. Actual departure and arrival time fields may be populated when the form is viewed for a trailer that has arrived at its destination.

In another embodiment, certain fields may be disabled until an initial trailer scan has been performed. In yet another embodiment, a trailer ID and a seal ID may be scanned into the data form only after the trailer is deemed ready for departure at a point of origin, but before the trailer begins its route.

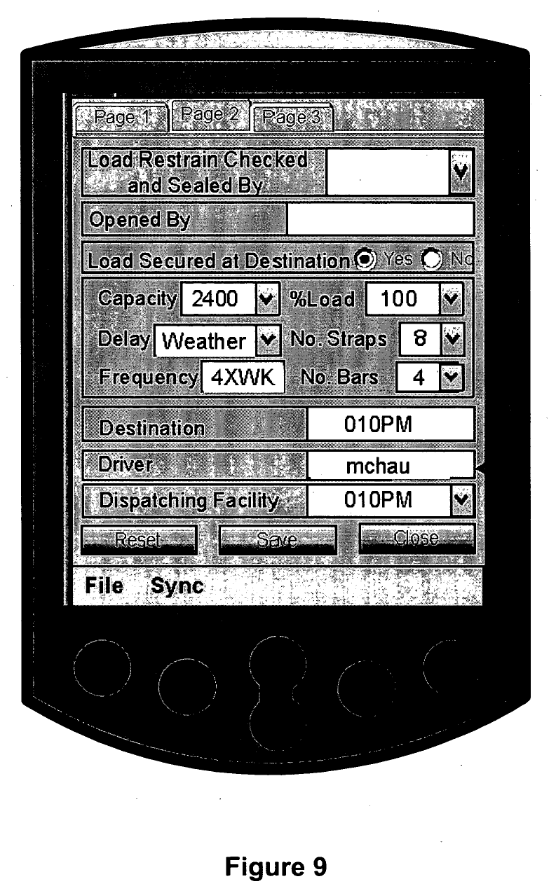

Clicking on page tabs may enable a user to toggle between pages. FIG. 9 depicts a screen of a generic PDA with a second exemplary page of an electronic data form. The second page of the data form may be accessed by clicking onto a tab entitled, for example, “Page 2.” At the point of destination, the employee may have to fill out several fields, such as for example, a “Load Restrain Checked and Sealed By” field or a “Capacity” field. A “Capacity” field may describe the size of a trailer, based on the trailer type. The capacity, or load density, may be displayed in units of 5, so that a trailer that is half-full (i.e., 50% loaded with shipments) would show 50 in this field. A “Delay” field may be populated with available dropdown options representing reason codes that might have caused a trailer to be delayed. For example, a code may represent mechanical failure of a trailer, while another code may represent traffic delays, and yet another code may represent inclement weather, as shown in FIG. 9. A “Frequency” field may be provided which may be, for example, a four character alphanumeric field. It may be populated automatically when a trailer is scanned to indicate the frequency of a route. In the example shown, the trailer is shown to be in use four times this week. A second page may also contain a “Trailer Destination” field. It may be automatically populated by the service provider's network when a trailer ID is scanned and a route is determined. A “Driver” field may be populated by a default driver of a route as found in a trip table. In another example, a “Driver” field may be modified by scanning a barcode on a driver's employee badge.

It is contemplated that the load capacity, or trailer capacity, may be continuously monitored using the present system. The mobile device or PDA can ascertain the trailer capacity based on the type of trailer being used, which type can be determined after the trailer ID data is scanned into the system. Thereafter, the movement of units (i.e., trailers, containers and individual packages) can be monitored to determine a current load density for that trailer. The deliverable units can be tracked by scanning their barcode, or entering their identification number, into the system via the mobile apparatus. Changes to the load density would be immediately. shared between the mobile device and the transportation network, so that an updated load density can be ascertained for the trailer with each disposition of a container, unit or package.

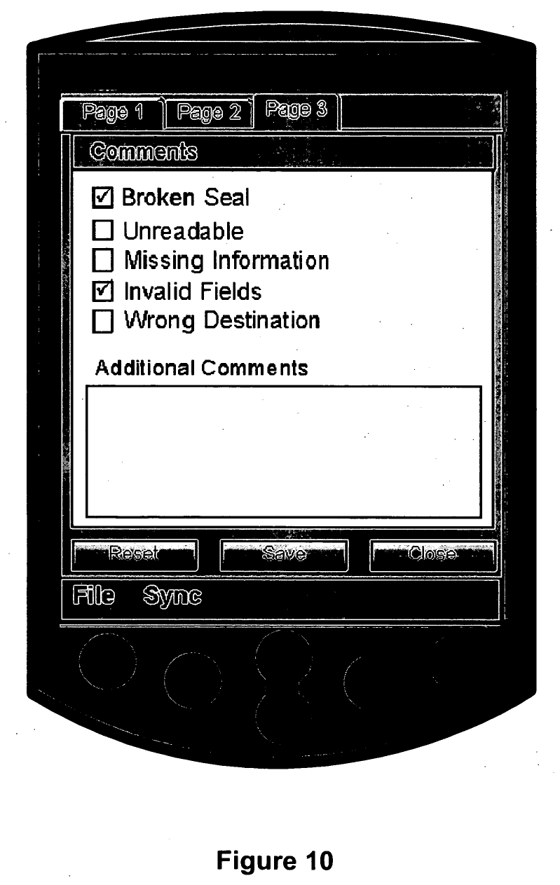

FIG. 10 depicts a screen of a generic PDA with a third exemplary page of a data capture form. The third page of a data form may be accessed, for example, by clicking on a tab entitled “Page 3.” This third page may contain a list of commonly used comments, such as the comments shown in FIG. 10. While in this form, the employee may designate a comment to be entered from a list of appropriate comments by checking off the corresponding boxes. In the alternative or in addition, a new comment may be created by entering the comment in an input text box.

Clicking a “Save” button from any page of the exemplary data form herein described (see FIGS. 8-10) may initiate a validation check of whether all required fields are filled in. At a point of origin, required fields may include, for example, a trailer ID, a seal ID, trip, route, load restrain checked and sealed by, a capacity, % loaded, a number of shoring bars or shoring straps, and a dispatching facility. If a required field is not filled in, a message such as ‘Please complete all required fields’ may appear. Fields with missing values may be highlighted in a different color. To proceed, a user may need to enter missing values and click the “Save” button again. If all required fields are filled out, the PDA may save entered data locally for uploading into the service provider's database.

When a trailer arrives at its point of destination, a service provider employee may access the data form screen from a main page to review the partially filled out data form for that trailer. A user scanning a seal ID may initiate a call to a network web server. If a data form has been entered into the service provider's database, the web service returns a record and the data form may be populated with different data, for example, a trailer ID, a seal ID, trip, route, load restrain checked and sealed by, a capacity, % loaded, a number of bars, a number of straps, and a dispatching facility. This information may also be displayed to the user. The same information may also be accessed by scanning a trailer ID.

After completely filling out the data form, data from that PDA may be uploaded onto an application server for loading it into an application such as, for example, Oracle. If uploading is successful, then the PDA application may continue. If there is an error, information may be returned to the device and the failure may be reported to the service provider network.

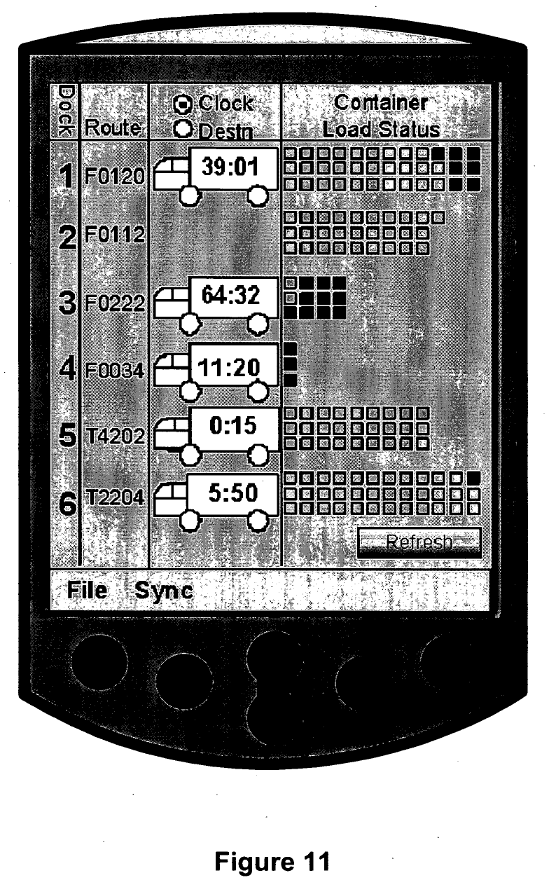

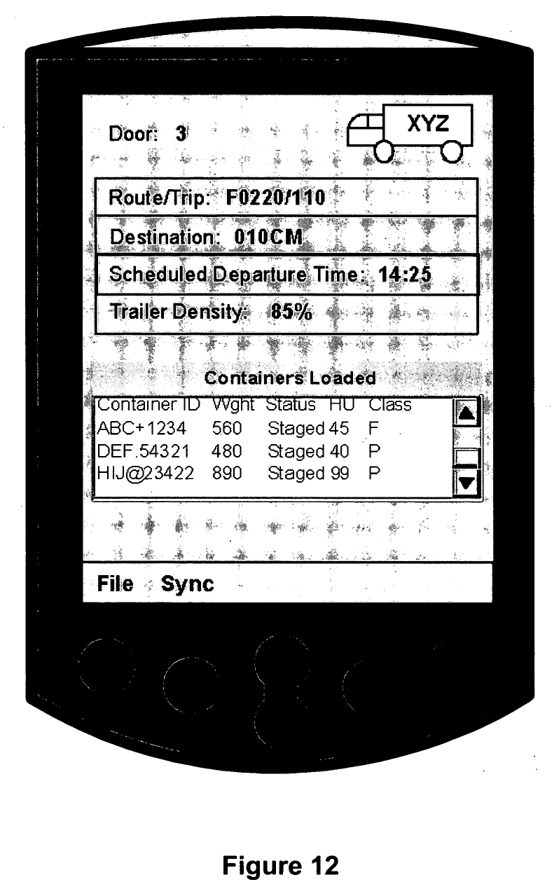

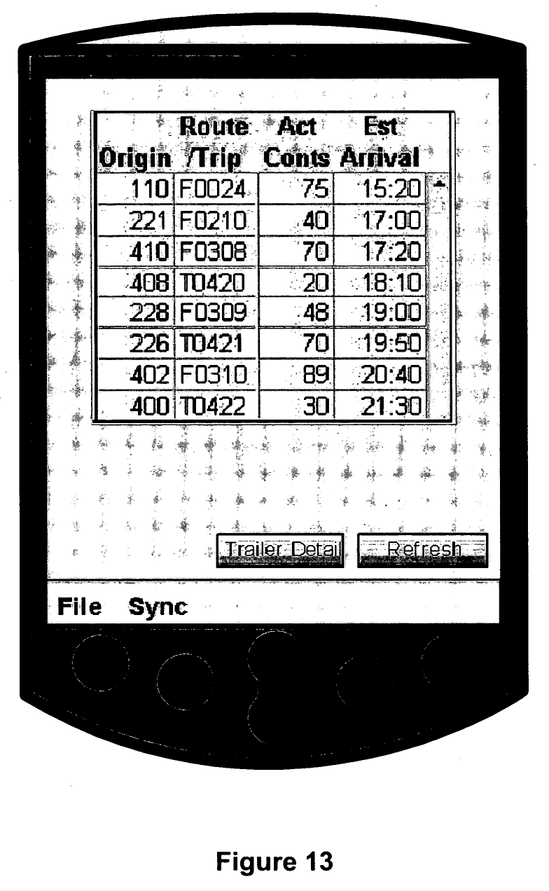

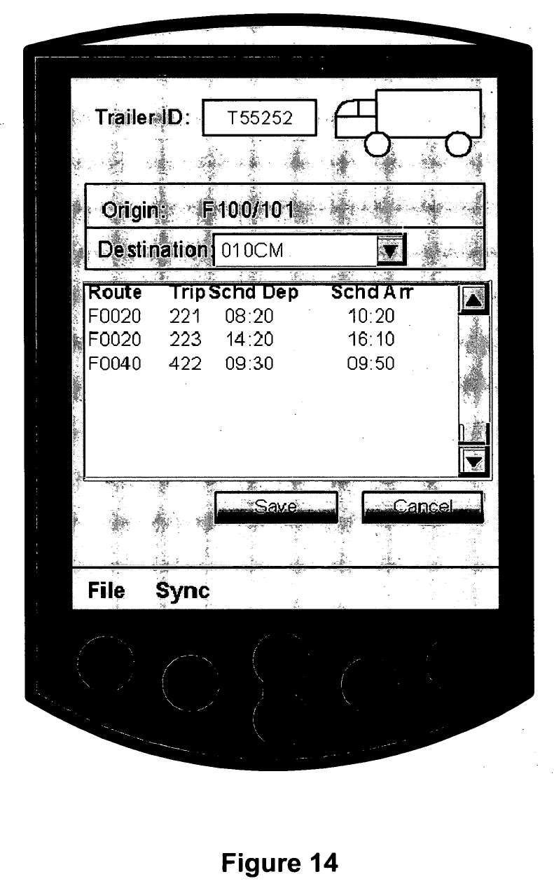

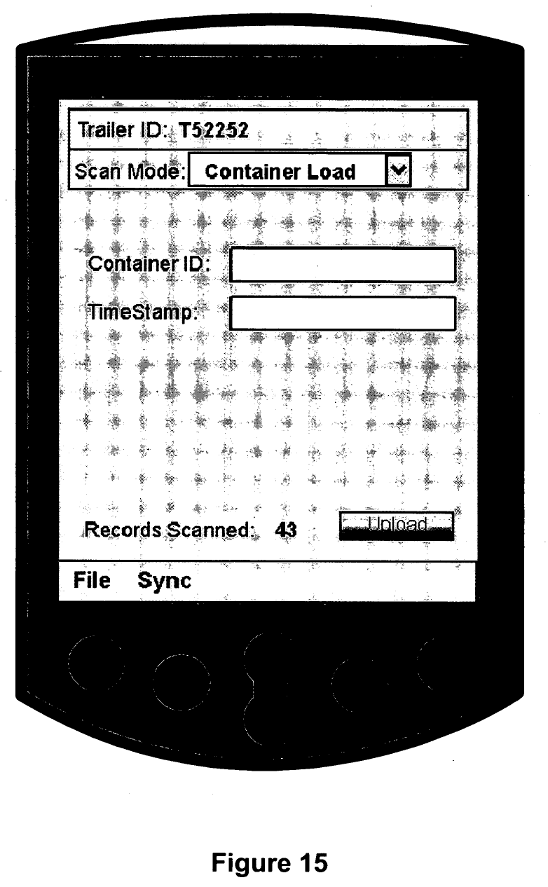

FIGS. 11-15 depict a generic PDA with exemplary screens of the different modes of operation. For example, FIG. 11 depicts an exemplary Dock Status screen. For each of the delivery routes being monitored, the trailer's container load status (i.e., load density) is shown, as well as the anticipated time until reaching its next destination. FIG. 12 depicts an exemplary screen for a single trailer or delivery truck with trailer details, such as the identification of the loaded packages and their weight and delivery class. FIG. 13 depicts an exemplary screen featuring inbound mode of operation, FIG. 14 depicts an exemplary Trailer Assignment screen showing the delivery routes for a particular trailer, and scheduled departure and arrival times for each route, and FIG. 15 depicts an exemplary screen featuring barcode scanning mode of operation.

It is contemplated that the mobile device of the present invention may also be used to determine the manner, or order, in which the packages may be loaded onto the trailer. For example, once all the relevant package data for a trailer has been loaded into the PDA, including such relevant data as the destination, weight, and/or class of the package, the employee may access a “Load Trailer” function of the PDA which would sort the data and determine, based in part on the order of the routes, the order that the packages need to be loaded into the trailer for their most efficient delivery. Further, the network and PDA may also be used to ascertain whether a partially loaded trailer already en route to a destination may be able to pick up an additional package or packages and assume the delivery of these new packages. This determination may be based on the load density available for that trailer, and the compatibility of the delivery route of the new package with the existing route schedule for that trailer. This feature would enable a trailer to be more efficiently utilized since the trailer does not have to report back to a centralized loading area before getting the message to pick up an additional package en route.

One skilled in the art will recognize that many alternative embodiments are possible. For example, different designs of screens with different information presented for each mode of a PDA operation may be used. In another example, a web server may confirm that no further updates of an application is necessary by sending to a PDA a specific message or greeting. In yet another example, scanned and manually entered values may not be saved until a user completes a form with all required fields and a “Save” button is clicked. Other alternatives are possible without departing from the spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for delivery management, comprising:
a web based server comprising an application server and a database server;
a mobile delivery management tool; and
a wireless communication device for connecting the mobile delivery management tool and the web based server.

2. The system of claim 1, further including at least one work station for accessing the web based server.

3. The system of claim 1, wherein the mobile delivery management tool comprises a memory for providing sufficient processing power and a storage for maximizing application performance.

4. The system of claim 1, wherein the web based server includes at least one of package delivery information, delivery vehicle information, and delivery personnel information.

5. The system of claim 4, wherein the package delivery information includes at least one of package identification number, package weight, package delivery class, package origination, package destination, scheduled departure time, and scheduled arrival time.

6. The system of claim 4, wherein the delivery vehicle information includes at least one of vehicle identification number, load capacity, load density, vehicle type, delivery route information, vehicle frequency information, and load contents.

7. The system of claim 4, wherein the delivery personnel information includes at least one of vehicle driver identification, package handler identification, authorized user identification, and work station user identification.

8. The system of claim 1, wherein the web based server provides scheduled departure and arrival times of a package upon communication with the mobile delivery management tool.

9. The system of claim 1, wherein the web based server provides route and trip information for a package upon communication with the mobile delivery management tool.

10. The system of claim 1, wherein the web based server provides trailer capacity and load density upon communication with the mobile delivery management tool.

11. The system of claim 1, wherein the web based server provides package loading order for a delivery vehicle upon communication with the mobile delivery management tool.

12. The system of claim 1, wherein the web based server updates old versions of software applications with current versions upon communication with the mobile delivery management tool.

13. The system of claim 1, wherein the mobile delivery management tool further comprises a barcode scanner for providing an interface for entering data into the database.

14. The system of claim 13, wherein the scanner is a hand-held scanner.

15. The system of claim 13, wherein the scanner includes a magnet for attachment to a magnetic surface.

16. The system of claim 1, wherein electronic service provider forms can be generated and submitted to the web based server using the mobile delivery management tool.

17. A method for managing delivery of a package, comprising:
providing a system for delivery management, comprising:
a web based server comprising an application server and a database server;
a mobile delivery management tool; and
a wireless communication device for connecting the mobile delivery management tool and the web based server;
collecting data related to a package to be delivered using the mobile delivery management tool; and
communicating the data to the web based server.

18. The method of claim 17, further including the step of receiving data related to the package to be delivered using the mobile delivery management tool.

19. The method of claim 18, wherein the mobile delivery management tool processes the received data to determines a delivery action to be taken.

20. The method of claim 19, wherein the action is the selection of a delivery route.

21. The method of claim 19, wherein the action is the selection of a scheduled delivery time.

22. The method of claim 19, wherein the action is the selection of a loading order.
